(19) United States
(12) Patent Application Publication
(10) Pub. No.: US 2019/0120184 A1
(43) Pub. Date: Apr. 25, 2019

(54) INTAKE DEVICE OF INTERNAL COMBUSTION ENGINE

(71) Applicant: HONDA MOTOR CO., LTD., Tokyo (JP)

(72) Inventor: Katsushi HASHIMOTO, Wako-shi (JP)

(21) Appl. No.: 16/140,074

(22) Filed: Sep. 24, 2018

(30) Foreign Application Priority Data
Oct. 23, 2017 (JP) 2017-204634

(51) Int. Cl. F02M 35/04; F02M 35/12

(52) U.S. Cl. CPC F02M 35/048; F02M 35/0201; F02M 35/1283; F02M 35/1255

(57) ABSTRACT

An intake device of an internal combustion engine includes: a first intake component defining an intake passage; and a second intake component having a side end part connected to the first intake component via a connecting part, and disposed above a main body of the internal combustion engine, wherein the connecting part is configured to connect the second intake component to the first intake component to be rotatable about a rotation axis that is inclined downward in a direction from the second intake component toward the first intake component.

### TECHNICAL FIELD

The present invention relates to an intake device of an internal combustion engine.

### BACKGROUND ART

In some internal combustion engines, a resonator is disposed above the head cover so that the resonator covers upper end parts of the spark plugs (see JP2005-248779A, for example). The resonator is detachably attached to the head cover by a fastener, and thus, can be removed from the head cover at the time of maintenance of the spark plugs.

In the structure disclosed in JP2005-248779A mentioned above, at the time of maintenance of the spark plugs, it is necessary to remove the resonator not only from the head cover but also from the intake pipe. Therefore, the work of removing the resonator is cumbersome. In addition, because the engine room is packed with various devices, the resonator tends to interfere with the structural parts around the resonator when being removed, and this hinders easy removal of the resonator.

### SUMMARY OF THE INVENTION

In view of such background, a primary object of the present invention is to provide an intake device that can allow maintenance to be performed easily without need for removing a component of the intake device disposed above the engine main body from the intake device.

To achieve the above object, an embodiment of the present invention provides an intake device (3) of an internal combustion engine (1), comprising: a first intake component (40) defining an intake passage; and a second intake component (46) having a side end part connected to the first intake component via a connecting part (54), and disposed above a main body of the internal combustion engine, wherein the connecting part is configured to connect the second intake component to the first intake component to be rotatable about a rotation axis (X) that is inclined downward in a direction from the second intake component toward the first intake component.

According to this arrangement, by rotating the second intake component without removing it from the intake device, an upper part of the main body of the internal combustion engine can be exposed to outside, whereby maintenance of spark plugs or other devices provided in the upper part of the main body of the internal combustion engine is allowed. Because the rotation axis is inclined, an amount of upward movement of the second intake component when rotated can be reduced, whereby interference between the second intake component and other structural parts therearound can be avoided. Owing to these features and advantages, the maintenance of the spark plugs or the like can be performed easily.

In this above arrangement, preferably, as seen in plan view, the connecting part is disposed in front of the second intake component, and the rotation axis extends in a front-rear direction, and the second intake component is disposed more forward than an imaginary plane (Y) orthogonally intersecting the rotation axis and in contact with a front edge of a cowl top (16) disposed above the main body of the internal combustion engine.

According to this arrangement, interference between the second intake component and the cowl top can be avoided when the second intake component is rotated.

In this above arrangement, preferably, the cowl top includes a weatherstrip (23) forming the front edge of the cowl top and contacting an engine hood.

According to this arrangement, interference between the second intake component and the weatherstrip forming the front edge of the cowl top can be avoided when the second intake component is rotated.

In this above arrangement, preferably, a rear edge of the second intake component is disposed more rearward than the front edge of the cowl top.

According to this arrangement, the second intake component and the cowl top can be located close to each other, whereby the second intake component can be disposed efficiently.

In this above arrangement, preferably, the connecting part includes a plurality of cylindrical pipes (45, 51, 52) fitted together to be rotatable with one another about the rotation axis.

According to this arrangement, the rotatable connecting part can be formed with a simple structure. Further, because the connecting part defines a passage, intake air can flow between the first intake component and the second intake component via the connecting part.

In this above arrangement, preferably, one of the cylindrical pipes has an annular engagement groove (56, 57) extending in a circumferential direction, and another one of the cylindrical pipes has a protrusion (61, 65) protruding radially outward to be engaged with the engagement groove.

According to this arrangement, the engagement between the engagement groove and the protrusion can prevent inadvertent separation of the cylindrical pipes.

In this above arrangement, preferably, the protrusion has an inclined surface (62, 66) extending obliquely outward from a tip end of the other one of the cylindrical pipes toward a base end of the same, and a check surface (63, 67) located closer to the base end than the inclined surface is and forming a surface perpendicular to the rotation axis, the inclined surface and the check surface each extending in the circumferential direction to have an annular shape.

According to this arrangement, inadvertent separation of the cylindrical pipes can be prevented even more reliably.

In this above arrangement, preferably, the main body of the internal combustion engine is mounted transversely, and the second intake component extends transversely and is connected to the connecting part at a left end part or a right end part thereof.

According to this arrangement, the second intake component can cover a wide area of the upper part of the main body of the internal combustion engine.

In this above arrangement, preferably, the second intake component includes a resonator.

According to this arrangement, the resonator, which has a relatively large volume, can be placed above the main body of the internal combustion engine efficiently.

In this above arrangement, preferably, the second intake component is detachably fastened to the main body of the internal combustion engine via a rubber bush (72).

According to this arrangement, the second intake component can be fixed to the main body of the internal combustion engine. Further, the rubber bush can suppress transmission of vibrations between the second intake component and the main body of the internal combustion engine.

According to the above arrangement, it is possible to provide an intake device that can allow maintenance to be performed easily without need for removing a component of the intake device disposed above the engine main body from the intake device.

### BRIEF DESCRIPTION OF THE DRAWINGS

FIG. 1 is a plan view of an internal combustion engine regarding an embodiment of the present invention;

FIG. 2 is a left side view of the internal combustion engine;

FIG. 3 is a sectional view of a connecting part;

FIG. 4 is a plan view of the internal combustion engine, showing a state where a resonator has been rotated; and

FIG. 5 is a left side view of the internal combustion engine, showing the state where the resonator has been rotated.

### DESCRIPTION OF THE PREFERRED EMBODIMENT(S)

In the following, description will be made of an embodiment in which the present invention is applied to an intake device of internal combustion engine of an automobile, with reference to the drawings. In the following description, front, rear, left, and right are defined with respect to the vehicle on which the internal combustion engine is mounted. Up and down are defined with respect to the vertical direction.

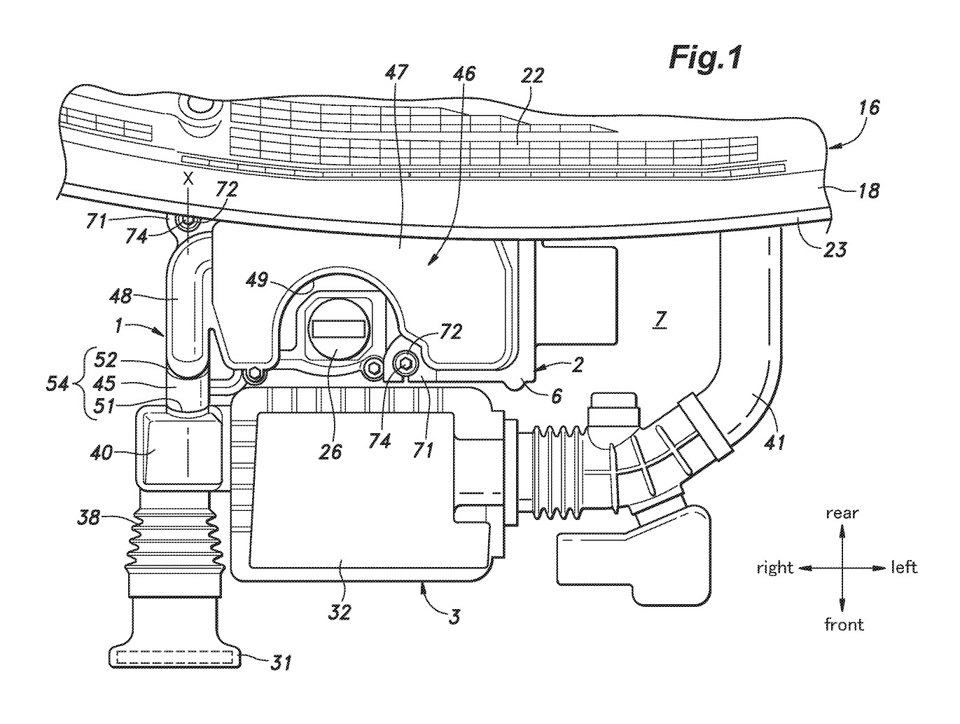

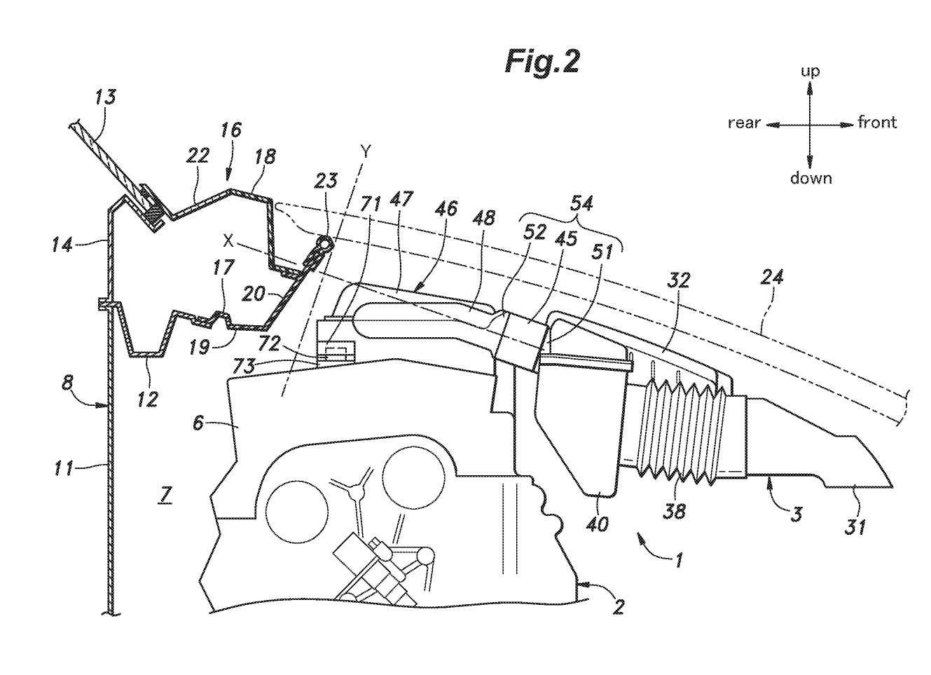

As shown in FIGS. 1 and 2, an internal combustion engine 1 includes an engine main body 2, an intake device 3 for supplying air to the engine main body 2, and an exhaust device for discharging exhaust gas from the engine main body 2. The engine main body 2 includes a cylinder block defining a plurality of cylinders connected in series, a cylinder head mounted on an upper part of the cylinder block, and a head cover 6 mounted on an upper part of the cylinder head to form an upper end part of the engine main body 2.

The internal combustion engine 1 is disposed in an engine room 7 defined in a front part of the vehicle. The rear end of the engine room 7 is defined by a dashboard 8. The dashboard 8 has a dashboard lower panel 11 having surfaces facing in the front and rear and extending in the vehicle width direction and in the vertical direction, and a dashboard upper panel 12 extending forward from an upper edge of the dashboard lower panel 11 and in the vehicle width direction. Further, provided on the upper edge of the dashboard lower panel 11 is a windshield lower member 14 that extends upward and forward and supports a lower edge of a windshield 13. The front edges of the windshield 13 and the windshield lower member 14 are disposed above the front edge of the dashboard upper panel 12.

A cowl top 16 is provided between the front edge of the dashboard upper panel 12 and the front edge of the windshield lower member 14. The cowl top 16 includes a cowl top lower panel 17 and a cowl top upper panel 18. The cowl top lower panel 17 has a bottom plate part 19 extending forward from the front edge of the dashboard upper panel 12, and a front plate part 20 extending upward from the front edge of the bottom plate part 19. The bottom plate part 19 and the front plate part 20 each extend in the vehicle width direction. The cowl top upper panel 18 is coupled to a front edge of a dash upper lid at a rear edge thereof, and is coupled to an upper edge of the front plate part 20 of the cowl top lower panel 17 at a front edge thereof. The cowl top upper panel 18 extends in the vehicle width direction. The cowl top upper panel 18 is formed with a plurality of vent holes 22. The cowl top lower panel 17 and the cowl top upper panel 18 are made of resin.

The cowl top 16 further includes a weatherstrip 23 at the upper edge of the front plate part 20. The weatherstrip 23 is configured to contact a rear edge of an engine hood 24 that openably covers an upper part of the engine room 7. The cowl top 16 closes a gap between the rear edge of the engine hood 24 and the front edge of the windshield 13.

The engine main body 2 is disposed in front of the dashboard lower panel 11 transversely; namely, such that the cylinder row direction is in parallel with the vehicle width direction. The engine main body 2 is disposed such that the intake side thereof faces forward. The head cover 6 is disposed lower than the bottom plate part 19 of the cowl top lower panel 17. In plan view, a rear part of the head cover 6 overlaps with the cowl top lower panel 17.

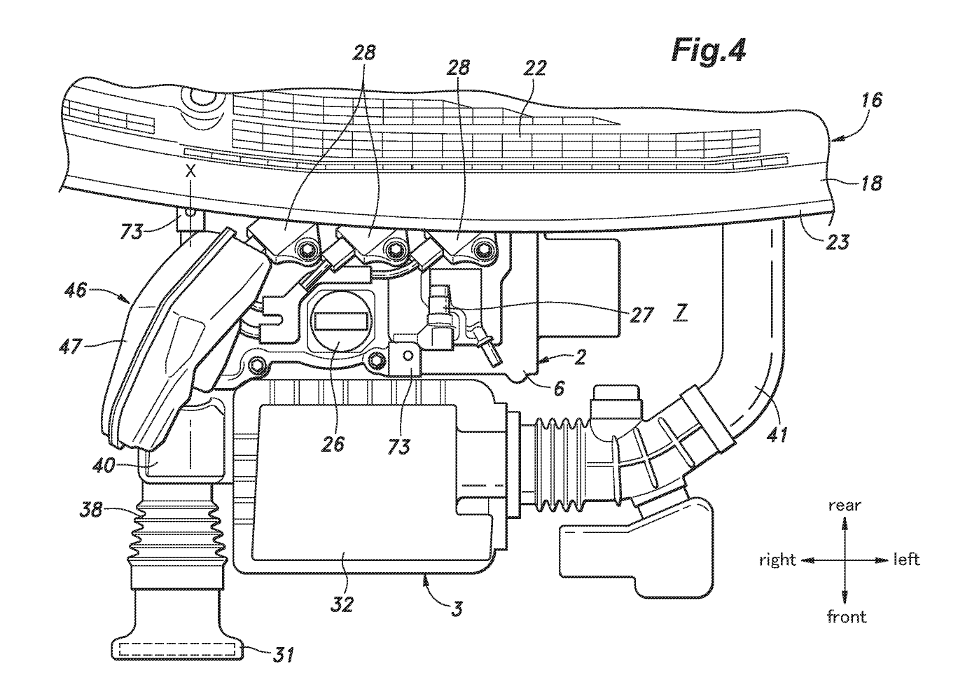

An oil filler cap 26 is provided in a front center part of an upper surface of the head cover 6, and a PCV valve 27 (see FIG. 4) is provided in a front left part of the upper surface of the head cover 6. Further, upper end parts of spark plugs 28 are provided in a central part of the upper surface of the head cover 6 with respect to the front-rear direction such that the upper end parts of the spark plugs 28 are arranged in the transverse (lateral) direction.

The intake device 3 defines a continuous intake passage for supplying air to the cylinders of the internal combustion engine 1, and includes, from an upstream side, an air inlet 31, an air cleaner 32, a compressor of a turbocharger, an intercooler, a throttle valve, and an intake manifold in this order. The intake manifold is connected to the front side of the cylinder head (engine main body 2), whereby the intake device 3 supplies intake air to the cylinders of the engine main body 2.

The air inlet 31 is constituted of a pipe extending in the front-rear direction, and has an air suction port at a front end thereof. The air inlet 31 is disposed in front of a right end of the engine main body 2 as seen in plan view. As shown in FIG. 2, the air inlet 31 is disposed at the substantially same height as the head cover 6. The air inlet 31 is supported by a vehicle frame.

The rear end of the air inlet 31 is connected to the air cleaner 32 via a first intake pipe 38 and an intake chamber 40 (first intake component) forming the intake passage. The first intake pipe 38 has a bellows structure, extends in the front-rear direction, and has a front end connected to the rear end of the air inlet 31. The intake chamber 40 is formed to have a substantially rectangular box-like shape and extends vertically. A lower part of the intake chamber 40 is disposed in front of a right end part of the head cover 6. An upper part of the intake chamber 40 protrudes more upward than the upper surface of the head cover 6. An upper surface of the intake chamber 40 is inclined downward toward the front to avoid contact with the engine hood 24. A rear end of the first intake pipe 38 is connected to a lower part of a front side surface of the intake chamber 40. A left side surface of the intake chamber 40 is connected to a right side surface of the air cleaner 32.

The air cleaner 32 is formed to have a substantially rectangular box-like shape and extends transversely. A lower part of the air cleaner 32 is disposed in front of the head cover 6, and an upper part of the air cleaner 32 protrudes more upward than the upper surface of the head cover 6. A left side surface of the air cleaner 32 is connected to the compressor of the turbocharger via a second intake pipe 41. The second intake pipe 41 extends leftward from the left side surface of the air cleaner 32, is bent rearward to extend rearward on the left side of the engine main body 2, and then is bent rightward to be connected to the compressor of the turbocharger disposed on the rear side of the engine main body 2.

A discharge port of the compressor is connected by an intake pipe to an inlet of the intercooler disposed on the left side of the engine main body 2 and below the second intake pipe 41. An outlet of the intercooler is connected by another intake pipe to the throttle valve placed on the entrance of the intake manifold. The intake manifold and the throttle valve are disposed in front of the engine main body 2 and below the air cleaner 32. The intake pipes connecting between the compressor and the intercooler and between the intercooler and the throttle valve are disposed below the second intake pipe 41 and along the second intake pipe 41.

An intake resonator 46 (second intake component) is connected to the intake chamber 40 via a connecting pipe 45. The intake resonator 46 includes a resonance room part 47 defining a resonance room, and a passage part 48 defining a passage extending from the resonance room. The resonance room part 47 is a flat hollow member that is thin in the vertical direction, is disposed above the head cover 6, and extends transversely. In plan view, the resonance room part 47 overlaps with all of the spark plugs 28 and covers a large part of the head cover 6. Further, a recess 49 is formed in a central part of the front edge of the resonance room part 47 such that the recess 49 is recessed rearward and extends vertically through the resonance room part 47. The recess 49 is located at a position in alignment with the oil filler cap 26 to expose the oil filler cap 26 from above in plan view. A rear end of the passage part 48 is connected to a rear portion of a right end part (example of a side end part) of the resonance room part 47, and extends from the rear end forward on the right side of the resonance room part 47.

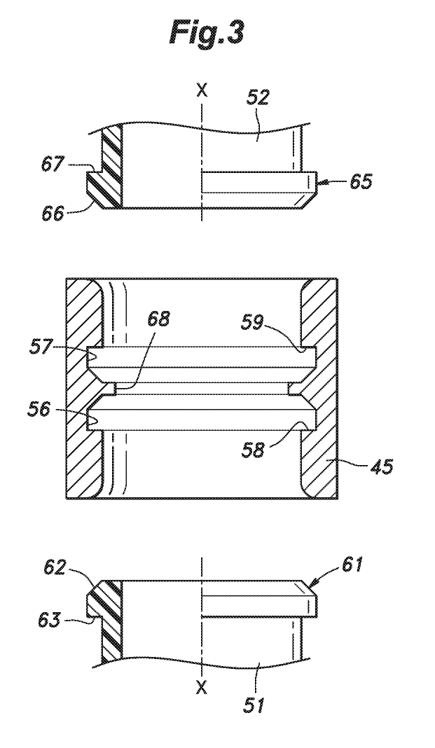

An upper part of a rear surface of the intake chamber 40 is provided with a chamber-side connecting pipe 51, and a front end of the passage part 48 is provided with a resonator-side connecting pipe 52. As shown in FIG. 3, the chamber-side connecting pipe 51, the resonator-side connecting pipe 52, and the connecting pipe 45 each consist of a cylindrical pipe. The chamber-side connecting pipe 51 is rotatably fitted into the front end of the connecting pipe 45 and the resonator-side connecting pipe 52 is rotatably fitted into the rear end of the connecting pipe 45, whereby the chamber-side connecting pipe 51, the resonator-side connecting pipe 52, and the connecting pipe 45 are arranged coaxially relative to each other. The chamber-side connecting pipe 51, the resonator-side connecting pipe 52, and the connecting pipe 45 can rotate relative to each other about a common rotation axis X. The chamber-side connecting pipe 51, the resonator-side connecting pipe 52, and the connecting pipe 45 constitute a connecting part 54 that connects the intake chamber 40 and the intake resonator 46 to each other. In plan view, the connecting part 54 is disposed in front of the intake resonator 46, and the rotation axis X extends in the front-rear direction.

The chamber-side connecting pipe 51, the resonator-side connecting pipe 52, and the connecting pipe 45 are inclined downward in a direction from the intake resonator 46 toward the intake chamber 40. Likewise, the rotation axis X also is inclined downward in the direction from the intake resonator 46 toward the intake chamber 40. The chamber-side connecting pipe 51 is inclined upward relative to the rear surface of the intake chamber 40 and protrudes rearward from the same. The resonator-side connecting pipe 52 is inclined downward relative to the passage part 48 and protrudes forward from the same.

Preferably, outer circumferential surfaces of the chamber-side connecting pipe 51 and the resonator-side connecting pipe 52 and an inner circumferential surface of the connecting pipe 45 are each formed to have a perfect circular cross-section and are in slidable contact with each other. Thereby, the chamber-side connecting pipe 51, the resonator-side connecting pipe 52, and the connecting pipe 45 can rotate smoothly relative to each other.

As shown in FIG. 3, an axially central part of the inner circumferential surface of the connecting pipe 45 is provided with a first engagement groove 56 and a second engagement groove 57 each extending in the circumferential direction to have an annular shape. The first engagement groove 56 is located more forward than the second engagement groove 57. A first groove wall 58 forming a front end side of the first engagement groove 56 and a second groove wall 59 forming a rear end side of the second engagement groove 57 each extend in the circumferential direction to have an annular shape. The first groove wall 58 and the second groove wall 59 are each formed to define a flat surface perpendicular to the rotation axis X.

The chamber-side connecting pipe 51 is provided on the outer circumferential surface thereof with a first protrusion 61 protruding radially outward to be engaged with the first engagement groove 56. The first protrusion 61 includes a first inclined surface 62 protruding (more specifically, extending obliquely outward) from a tip end (rear end) of the chamber-side connecting pipe 51 toward a base end (front end) of the same, and a first check surface 63 located closer to the base end side than the first inclined surface 62 is and defining a flat surface perpendicular to the rotation axis X. Engagement of the first check surface 63 with the first groove wall 58 prevents the chamber-side connecting pipe 51 from being inadvertently separated from the connecting pipe 45.

The resonator-side connecting pipe 52 is provided on the outer circumferential surface thereof with a second protrusion 65 protruding radially outward to be engaged with the second engagement groove 57. The second protrusion 65 includes a second inclined surface 66 protruding (more specifically, extending obliquely outward) from a tip end (front end) of the resonator-side connecting pipe 52 toward a base end (rear end) of the same, and a second check surface 67 located closer to the base end than the second inclined surface 66 is and defining a flat surface perpendicular to the rotation axis X. Engagement of the second check surface 67 with the second groove wall 59 prevents the resonator-side connecting pipe 52 from being inadvertently separated from the connecting pipe 45.

The connecting pipe 45 is made of a resin material having flexibility. When the chamber-side connecting pipe 51 and the resonator-side connecting pipe 52 are inserted into the connecting pipe 45, the first inclined surface 62 and the second inclined surface 66 force the corresponding opening ends of the connecting pipe 45 to widen.

A part of the inner circumferential surface of the connecting pipe 45 between the first engagement groove 56 and the second engagement groove 57 is provided with a restriction wall 68 that protrudes radially inward and extends in the circumferential direction. The restriction wall 68 is configured to abut on the tip end (rear end) of the chamber-side connecting pipe 51 and the tip end (front end) of the resonator-side connecting pipe 52 to thereby restrict the depth of insertion of the chamber-side connecting pipe 51 and the resonator-side connecting pipe 52 into the connecting pipe 45.

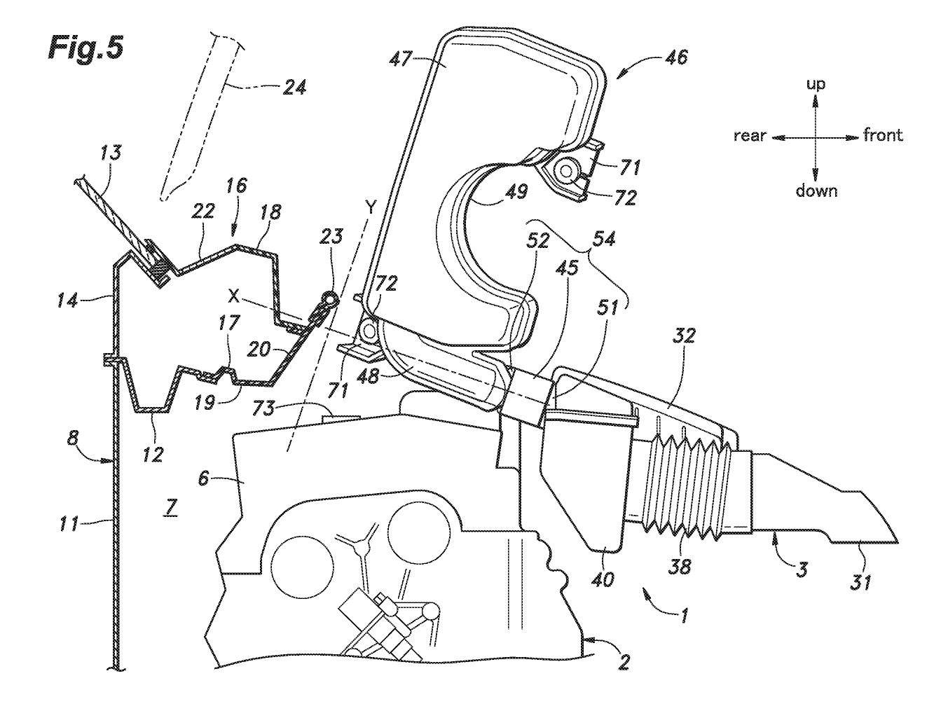

As shown in FIGS. 4 and 5, at least one of the relative rotation between the chamber-side connecting pipe 51 and the connecting pipe 45 and the relative rotation between the resonator-side connecting pipe 52 and the connecting pipe 45 allows the intake resonator 46 to rotate relative to the intake chamber 40 about the rotation axis X. Thereby, the intake resonator 46 can rotate between an initial position where the resonance room part 47 is disposed to the left of the passage part 48 (see FIGS. 1 and 2) and an upright position where the resonance room part 47 is disposed above the passage part 48 (see FIGS. 4 and 5). As shown in FIG. 4, in the upright position, the resonance room part 47 is separated from the head cover 6, and the upper end parts of the spark plugs 28 and the PCV valve 27 are exposed upward. It is to be noted that, when the intake resonator 46 is moved to the upright position, the engine hood 24 is opened beforehand (see FIG. 5).

As shown in FIG. 2, the intake resonator 46 is disposed more forward than an imaginary plane Y orthogonally intersecting the rotation axis X and in contact with front edge of the cowl top 16 (more specifically, the weatherstrip 23). Thereby, as shown in FIG. 5, it is ensured that when the intake resonator 46 is rotated about the rotation axis X, the intake resonator 46 does not interfere with the cowl top 16. As shown FIGS. 1 and 2, preferably, the intake resonator 46 is disposed more forward than the imaginary plane Y such that the rear edge of the intake resonator 46 is disposed more rearward than the front edge of the cowl top 16. By disposing the intake resonator 46 in such a manner, the intake resonator 46 can be positioned close to the cowl top 16, and thus, the intake resonator 46 can be disposed in a space-efficient manner.

As shown in FIGS. 1 and 2, the intake resonator 46 is provided with at least one fastening plate 71. The fastening plate 71 is formed with a through hole, to which a rubber bush 72 is fitted. The intake resonator 46 is releasably fixed in the initial position by a threaded bolt 74 passed through the rubber bush 72 and threadably engaged with a fastening seat 73 provided to the head cover 6. The intake resonator 46 contacts the head cover 6 via the rubber bush 72, and thus, transmission of vibrations between the head cover 6 and the intake resonator 46 can be suppressed.

In the structure described above, by rotating the intake resonator 46 without removing it from the intake device 3, an upper part of the engine main body 2 can be exposed to outside. Thereby, maintenance of the spark plugs 28 and the PCV valve 27 provided in the upper part of the engine main body 2 is allowed. Because the rotation axis X is inclined downward toward the front, an amount of upward movement of the intake resonator 46 when rotated can be reduced, whereby interference between the intake resonator 46 and the cowl top 16 can be avoided. Further, because the intake resonator 46 is disposed more forward than the imaginary plane Y orthogonally intersecting the rotation axis X and in contact with the front edge of the cowl top 16, the interference between the intake resonator 46 and the cowl top 16 can be avoided without fail. Owing to these features and advantages, the maintenance of the spark plugs or the like can be performed easily.

In the foregoing, a concrete embodiment of the present invention has been described, but the present invention is not limited to such an embodiment, and various modifications and alterations may be possible. For example, the connecting part 54 may be configured not to include the connecting pipe 45, such that the chamber-side connecting pipe 51 and the resonator-side connecting pipe 52 are directly fitted to each other in a relatively rotatable manner. In such a case, an engagement groove to be engaged with the first protrusion 61 of the chamber-side connecting pipe 51 may be formed in the resonator-side connecting pipe 52, or an engagement groove to be engaged with the second protrusion 65 of the resonator-side connecting pipe 52 may be formed in the chamber-side connecting pipe 51.

The connecting pipe 45 may be flexible or bendable. Also, the part to which the intake resonator 46 is connected is not limited to the intake chamber 40, and may be any member of the intake device 3 forming the intake passage.

In the foregoing embodiment, the weatherstrip 23 was positioned most forward of the parts of the cowl top 16, but in another embodiment, a front edge of the bottom plate part 19 or the front plate part 20 of the cowl top lower panel 17 may be positioned most forward of the parts of the cowl top 16.

1. Intake device of an internal combustion engine, comprising:
a first intake component defining an intake passage; and
a second intake component having a side end part connected to the first intake component via a connecting part, and disposed above a main body of the internal combustion engine,
wherein the connecting part is configured to connect the second intake component to the first intake component to be rotatable about a rotation axis that is inclined downward in a direction from the second intake component toward the first intake component.

2. The intake device as defined in claim 1, wherein as seen in plan view, the connecting part is disposed in front of the second intake component, and the rotation axis extends in a front-rear direction, and
the second intake component is disposed more forward than an imaginary plane orthogonally intersecting the rotation axis and in contact with a front edge of a cowl top disposed above the main body of the internal combustion engine.

3. The intake device as defined in claim 2, wherein the cowl top includes a weatherstrip forming the front edge of the cowl top and contacting an engine hood.

4. The intake device as defined in claim 2, wherein a rear edge of the second intake component is disposed more rearward than the front edge of the cowl top.

5. The intake device as defined in claim 1, wherein the connecting part includes a plurality of cylindrical pipes fitted together to be rotatable with one another about the rotation axis.

6. The intake device as defined in claim 5, wherein one of the cylindrical pipes has an annular engagement groove extending in a circumferential direction, and
another one of the cylindrical pipes has a protrusion protruding radially outward to be engaged with the engagement groove.

7. The intake device as defined in claim 6, wherein the protrusion has an inclined surface extending obliquely outward from a tip end of the other one of the cylindrical pipes toward a base end of the same, and a check surface located closer to the base end than the inclined surface is and forming a surface perpendicular to the rotation axis, the inclined surface and the check surface each extending in the circumferential direction to have an annular shape.

8. The intake device as defined in claim 1, wherein the main body of the internal combustion engine is mounted transversely, and
the second intake component extends transversely and is connected to the connecting part at a left end part or a right end part thereof.

9. The intake device as defined in claim 1, wherein the second intake component includes a resonator.

10. The intake device as defined in claim 9, wherein the second intake component is detachably fastened to the main body of the internal combustion engine via a rubber bush.
